(19) United States
(12) Patent Application Publication
(10) Pub. No.: US 2018/0291610 A1
(43) Pub. Date: Oct. 11, 2018

(54) System and Method for Identifying and Inspecting a Drain

(71) Applicants: John Henry, Rockwall, TX (US); Graham C. Henry, Royse City, TX (US)

(72) Inventors: John Henry, Rockwall, TX (US); Graham C. Henry, Royse City, TX (US)

(21) Appl. No.: 15/948,814

(22) Filed: Apr. 9, 2018

Related U.S. Application Data
(60) Provisional application No. 62/483,249, filed on Apr. 7, 2017.
(60) Provisional application No. 62/504,313, filed on May 10, 2017.

(51) Int. Cl. E03F 5/04; G06K 19/06; G06K 19/077

(52) U.S. Cl. CPC E03F 5/041; G06K 19/07773; G06K 19/06037; G06K 19/06028

(57) ABSTRACT

A system and method for inspecting drains and drain grates wherein a machine-readable code is applied to a drain grate. A reader scans and reads an identification (ID) code applied to the grate. The drain ID is transmitted with the inspection results to a server which saves the data.

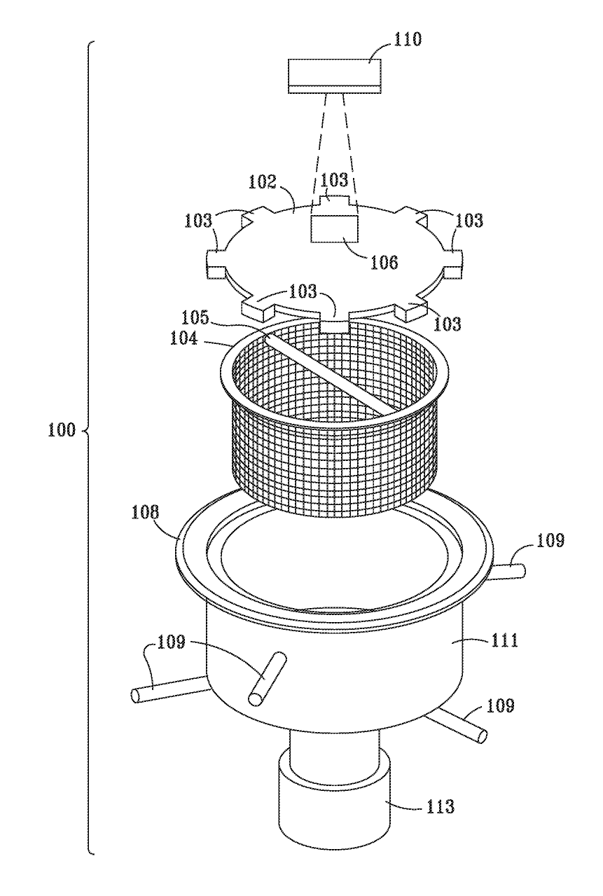

### CROSS-REFERENCE TO RELATED APPLICATIONS

This application claims the benefit of U.S. Provisional Application No. 62/483,249, filed Apr. 7, 2017, and U.S. Provisional Application No. 62/504,313, filed May 10, 2017, both of which applications are hereby incorporated herein by reference, in their entirety.

### TECHNICAL FIELD

The invention relates generally to identification and inspection of drains and, more particularly, to a system and method for identifying and inspecting drains.

### BACKGROUND

It is important to maintain high standards of sanitation in a number of commercial establishments and facilities, such as food plants, dairy plants, meat-packing plants, chicken plants, beer plants, restaurants, food facilities, hospitals, and the like. Such establishments are periodically audited by the USDA and FDA, as well as private third parties, such as Echo Labs, to inspect for germs such as E. coli bacteria, Listeria bacteria, and the like. A typical audit entails an inspector inspecting a number of items, including drains and other equipment. The inspector typically conducts an audit using a clipboard and manually entering information. Because information is entered manually, it is subject to human error, or if there is a problem, the records could be changed. Therefore, what is needed is a system and method which enables the entry of drain data, which data is less susceptible to human error or change by a human.

### SUMMARY

The present invention, accordingly, provides a system and method for inspecting drains wherein a machine-readable code is applied to the top and/or bottom of a drain grate. A reader scans and reads the code applied to the grate, and transmits the scanned data to a server which saves the data.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the attached drawing showing a perspective view of an industrial drain with a grate removed.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

Referring to the drawing, the reference numeral 100 generally designates an entire drain to be identified and inspected in accordance with principles of the present invention. Drain 100 includes a body 111 having a lip 108 and anchor tabs 109, and is coupled in fluid communication to a drain pipe 113. A screen basket 104 having a handle 105 is preferably positioned in body 111 for preventing large items from going down drain pipe 113. A drain grate 102 is preferably positioned like a cover over drain body 111. Drain grate 102 preferably includes feet 103 to slightly elevate it over the lip 108 to thereby permit liquids and debris to collect in body 111 of drain 100. It may be appreciated that drain 100 may be any of a number of different types of drains, such as a clean-out, a hub drain, or the like.

In accordance with principles of the present invention, the top and/or bottom of grate 102 is provided with a marking 106 to identify it in any desirable manner, such as by laser engraving. Marking 106 is preferably compatible with data collection technology, such as bar code (including any 2D linear bar code and 3D matrix bar code (e.g., QR code)), radio-frequency identification (“RFID”), touch memory, a micro-chip, a magnetic stripe, a proximity card, a smart card, and the like, all of which will be represented collectively herein as bar code. A data collection technology enabled reader device 110, preferably handheld (e.g., a smart phone, tablet, or the like), effective for reading the bar code, such as a laser scanner or camera, is provided for scanning or reading the bar code. Reader device 110 is preferably coupled in data communication with a remote server, preferably in the cloud (not shown), having software executable for storing data in a database and analyzing and reporting the data. The marking preferably includes a drain number which uniquely identifies the drain, and may optionally include a serial number of the drain, though the serial number may not necessarily be unique among drains.

In operation, once bar code 106 is applied to grate 102, an operator powers-up reader device 110 and the device connects with the server. The server downloads relevant data configuration files and any changes (e.g., additional data fields) thereto. Reader device 110 is then used by the operator to preferably capture the drain number (and optionally the serial number) of a drain, location of the drain, date-time stamp, operator name, operation code, and operator comments (e.g., repair drain, identify debris in drain, or take swab for germ testing). In a preferred embodiment, data, once entered into reader device 110, may not be altered by the user. Reader device 110 sends all the captured information to the server for storage.

When the server receives data, it preferably performs, among other functions, data quality checks, such as checking to confirm that a drain number is a valid number (e.g., not a number from a pack of cigarettes). If a drain number on a drain is not readable, then the server software can be configured to look at a list of drains in the area and suggest a drain number that an operator may select from. If a portion of a drain number is readable, then the server may suggest drain numbers that include that portion of the drain number.

In alternate embodiments, the bar code may be applied to the body of the drain instead of the grate (cover), or it may be applied to lip 108 of drain 100. Drain bar code 106 may alternatively be applied to an object proximate to the drain, such as a structural support column. The scan of a bar code on a column could also be used to confirm where an employee was at a certain date and time. The invention may be used with objects other than drain grates, such as factory equipment. Drain grate 102 may also be provided with a human readable drain number and, optionally, serial number.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A system for identifying and inspecting drains and drain grates, the system comprising:
a drain grate having a machine-readable code applied to it;
a device configured for scanning and reading the code applied to the drain grate and for receiving inspection results; and
a server in data communication with the reader.

2. The system of claim 1 wherein the code is a bar code.

3. The system of claim 1 wherein the code is a linear (1D) bar code.

4. The system of claim 1 wherein the code is a matrix (2D) bar code.

5. The system of claim 1 wherein the code is RFID.

6. The system of claim 1 wherein the code is RFID-GPS.

7. A method for inspecting drains and grates comprising:
applying a machine-readable identification (ID) code onto a drain grate;
reading the code;
saving the ID code to a device;
inspecting the drain;
entering inspection results into the device; and
transmitting the ID code and inspection results to a server for storage and analysis.

8. The method of claim 7 wherein the step of applying further comprises steps of using a laser to engrave the computer-readable code onto a drain grate.

9. The method of claim 7 wherein the code is a bar code.

10. The system of claim 7 wherein the code is a linear (1D) bar code.

11. The system of claim 7 wherein the code is a matrix (2D) bar code.

12. The method of claim 7 wherein the code is RFID.
